(19) United States
(12) Patent Application Publication
(10) Pub. No.: US 2014/0234573 A1
(43) Pub. Date: Aug. 21, 2014

(54) Molded and drawn screen

(71) Applicant: Peter B. Lindgren, Pompano Beach, FL (US)

(72) Inventor: Peter B. Lindgren, Pompano Beach, FL (US)

(21) Appl. No.: 14/184,269

(22) Filed: Feb. 19, 2014

Related U.S. Application Data
(60) Provisional application No. 61/766,434, filed on Feb. 19, 2013.

(51) Int. Cl. B29D 28/00

(52) U.S. Cl. CPC B29D 28/00
USPC 428/135; 264/328.1; 264/235.6; 428/131; 428/134

(57) ABSTRACT

A plastic barrier screen that is molded and drawn; the screen is formed from a process that uses the speed of injection molding to form a part that can be mechanically oriented in a second operation that is equally fast. The plastic barrier screen is first formed from injection molding a part with multiple square or hexagonal holes ½ to ⅙ opening size in a uniform pattern, including longitudinal dividers between such holes of 2 to 6 times the final desired screen barrier cross sectional area of the longitudinals respectively. The molded part is then stretched along the longitudinal elements of the mold to molecularly orient at elevated temperature to produce a larger planar dimension of 2 to 6 times the original plastic screen with high strength molecularly oriented monofilament longitudinal elements.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 61/766,434 entitled MOLDED AND DRAWN SCREEN having a filing date of Feb. 19, 2013, the contents of which are incorporated herein by reference.

### FIELD OF THE INVENTION

This invention is related to the field of screen technologies and in particular to a molded and drawn screen suitable for use in dynamic conditions such as open ocean aquaculture or static conditions such as geogrids.

### BACKGROUND OF THE INVENTION

Screen technologies can be used for numerous applications. Aquaculture or fish farming is a large and important industry worldwide that employ screen technologies for caging of fish. The use of screen technologies for geogrids, a screen used to help hold soil and growth in place (e.g. along highways) is another known use.

Ocean farming is becoming more popular because of demand for salt water fish and its health benefits. Fish farming or open ocean aquaculture is the rearing of marine organisms under controlled conditions in exposed high energy ocean environments. The open ocean aquaculture facilities consist of cages, holding pens, or the like that can be free floating, secured to a structure, or lowered to the ocean bottom. Open ocean aquaculture also makes use of the vast area of the ocean wherein cage size is not limited, as compared to the placement of cages within bays or the like tightly boarded area. The fish farming industry has enjoyed a steady strong growth for many years and can produce sustainable high quality fish products.

A plastic woven screen called Kikko net resembles a chain link fence with a double twist intersection. It has achieved some use and success, but still includes spaces to hide fouling at the twist and it is not flat for easy cleaning. The cost is also very high compared to netting. Copper screen does not accumulate fouling growth and can meet all of the requirements at a very high price and weight. Special means are required to deal with the additional weight of copper net and the lifespan is currently estimated at 4-5 years and recycling is required.

While fish farming has been around for thousands of years, yet in many ways it is still in its infancy. Environmental concerns and labor rates of the developed countries are the new barriers for continued growth of the industry. Keeping aquaculture cages clean, secure of fish escape and predator attack are challenging fish farm problems. Keeping fish cages clean to insure proper water flow and disease control is often the second largest cost of offshore fish farming behind feed. Sharks, sea lions, seals and other predators are a constant threat to the integrity of the screen. There is also a risk that escaped fish will breed with wild fish and cause problems including upsetting the balance between wild species. Cod fish have been known to chew their way out of cages made from bullet proof vest fibers like Dynema and Trigger fish have chewed their way in to get shrimp. Sharks are drawn to mortalities that sink to the bottom of the cage and should they enter the cage they enjoy easy feeding and become a threat to maintenance divers. Many farms have additional predator nets to keep predators away from cage nets. Seal lions and seals are known to push their face into the net and bite a fish to munch and suck as much as they can from it.

What is needed is a screen with more rigidity and something to deter the predators or make it more difficult. Currently most cages use common fish type nets that are difficult to clean because marine fouling can remain between the fibers and new growth returns shortly after cleaning. Normally nets are dipped or painted with antifouling poisons to reduce growth, but this comes off with cleaning and is a known environmental problem. Antifouling material that reaches the ocean or bay floor can reduce the ability of the floor to deal with by-products from the fish. The most effective antifouling paints are already banned in the United States.

Attempts to make screens by ultrasonic welding or other means to connect monofilaments or injection molding of screen for aquaculture use have been attempted with some success, limited speed of the process or the high cost of large equipment and tooling to achieve adequate size have made these process too expensive. Also maximum physical properties are not achieved. Many new products are available with limited use because of cost and effectiveness.

Mercer, Arechavaleta and others have disclosed technologies that form a net using a special extrusion head with rotating and crossing plastic extradate exits. This process can also be post molecularly oriented. However, this process cannot produce round members ideal for cleaning, or additional features of the current invention. The process also creates sharp and usually inconsistent edges not acceptable for modern cleaning equipment. U.S. Pat. No. 2,919,467; U.S. Pat. No. 3,051,987; U.S. Pat. No. 3,070,840; U.S. Pat. No. 3,791,784 and U.S. Pat. No. 3,874,834 are examples of patents that disclose this technology.

A modified extrusion process is described by Gaffney U.S. Pat. No. 3,723,218 with extruded crossing strands. Nalle Jr. U.S. Pat. No. 4,399,184 describes crossing layers of filaments being fused together to make a net like structure. There is a field of patents using co extruded monofilaments such as Mudge U.S. Pat. No. 4,656,075. They use a high strength high temperature material and a bonding lower temperature layer. This has inherently weak intersections.

Another known technology for forming a net like structure is to extrude a sheet of polypropylene and punching holes in the sheet. The sheet can then be heated and stretched to produce a panel with holes and molecularly oriented flat strips forming the boundary of the holes. Kalwaites U.S. Pat. No. 3,632,269 and U.S. Pat. No. 3,666,609 describes problems and improvements to this process. Kelly U.S. Pat. No. 4,381,326 uses extruded sheet and special polymers that allow a stretch ratio of greater than one. Korpman U.S. Pat. No. 4,062,995 describes a film of thermoplastic sheet from special formulated polymers that will recover when stretched. Cederblad U.S. Pat. No. 6,692,606 uses extrusion with fabric to form a net.

What is lacking in the art is a light weight screen that is molded and drawn for use with aquaculture and other application wherein the screen has significant strength and is capable of most any environmental condition including predator attacks, resisting of growth from barnacles, biomass, grass or the like substances.

### SUMMARY OF THE INVENTION

A screen formed from a process that uses the speed of injection molding to form a part that can be mechanically oriented in a second operation that is equally fast. Using 90 inches as a maximum width dimension for convenient shipping containers can require a molded part of less than 30 inches with a stretched draw ratio of 3:1.

An objective of the invention is to disclose a plastic screen that is molded and then drawn, the screen is formed from an injection molding process and mechanically oriented in a second operation having a draw ratio of about 3:1.

Another objective of the invention is to disclose an aqua cultural cage formed from multiple segments that are mechanically connected to one another to construct an effective screen for the cage.

Still another objective of the invention is to disclose a screen that can include features along the perimeter to easily attach to the stretching mechanism for the molecular orienting.

Still another objective of the invention is to disclose a screen that can include perimeter features to connect sections together to required sizes of current farms.

Yet still another objective of the invention is to disclose a screen wherein intersections of the screen include features included in the molding process such as a pointed cone or other shape at the intersections perpendicular to the screen plane on the external surface that will discomfort a predator from pressing against the screen.

Still another objective of the invention is to disclose a screen that can be injection molded at one location and stretched at another location, thereby providing efficiencies in shipping size.

Still another objective of the invention is to disclose a screen that is stretched mechanically to molecularly orient plastic monofilaments to increase the tensile strength up to 10 times the unprocessed tensile strength.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE DRAWINGS

FIG. 1 is a perspective view of an injection molded screen;

FIG. 2 is a perspective view of FIG. 1 after stretching of the screen;

FIG. 3 is a perspective view of an injection molded screen with molded intersections;

FIG. 4 is a perspective view of FIG. 3 after stretching of the screen;

FIG. 5 is a perspective view of a perimeter feature illustrate a male and female coupling;

FIG. 6 is a side view of FIG. 5;

FIG. 7 is a perspective view of the male coupled to the female perimeter feature;

FIG. 8 is a top perspective view of an injection molded screen with point cones along the molded intersections;

FIG. 9 is an enlarged section B of FIG. 8;

FIG. 10 is a bottom perspective view of FIG. 8

FIG. 11 is an enlarged section C of FIG. 10;

FIG. 12 is a perspective view of multiple screens attached along the perimeter feature.

### DETAILED DESCRIPTION OF THE PREFERRED EMBODIMENT

The screen technology described herein can be use in numerous applications. Open ocean aquaculture is considered the most demanding application for the use of screens placed into the ocean environment are subject to attack by predators while the screen must be capable of cleaning. For simplicity purposes, the specification that follows is directed to the molded and drawn screen technology for use in ocean farming situation in view of its most demanding conditions, however, the molded and drawn screen technology is also applicable to static conditions such as geogrids.

Disclosed is a fish and or predator barrier screen constructed from plastic materials. In particular the plastic materials are made by an injection molded part with multiple, essentially square, holes ½ to ⅙ of the final desired opening size in a uniform pattern, including longitudinal dividers between such holes of 2 to 6 times the final desired screen barrier cross sectional area of the longitudinals respectively. The preferred material is PET monofilament. However, other thermoplastic materials could be used including nylon, polyester, polyethylene, polypropylene and alloys and copolymers. The latter materials are better suited where the screen is used for a geogrid.

The current invention uses the speed of injection molding to form a part that can be mechanically oriented with special equipment in a second operation that is equally fast. Using 90 inches as a maximum width dimension for convenient shipping containers can require a molded part of less than 30 inches with a stretched draw ratio of 3:1 and a molding machine of about 400 tons. Such machines are readily available. The result is a higher strength screen than produced through injection molding. Further, the screen is easier to clean because of its smooth round surface. Because the parts are injection molded and then molecularly oriented by stretching the mold can include perimeter features to connect sections together to required sizes of current farms.

Current offshore cages are generally very large. 3000 to 10,000 cubic meters are now common. An example cage might be 20 m×20 m×20 m. This requires huge net or screen panels. Copper and other plastic screen products are available in relatively narrow rolls and are difficult to connect together, modify and repair. The injection molded part in the present invention can include features at the part perimeter to easily attach to the stretching mechanism for the molecular orienting and to each other. This allows the formation of unlimited size configuration for large cages from panels that can ship in conventional trucks and ocean containers. This process can result in a problematic disfiguration of the perimeter features during stretching. The solution is to insulate the perimeter features in the heating process or to cool them with cold tooling if the parts are moved directly from the molding machine hot after molding.

One problem that results from molecularly orienting a molded screen in two directions is that the intersection can orient in a direction leaving insufficient strength to molecularly orient in the second direction without failure at the intersection. This problem can be avoided by adding material at the intersection sufficient to inhibit orientation in the center or intersection area. With the added material at the intersections the stretching slows and stops before it causes a problem for the adjacent material.

The intersections of the screen can also have features included in the molding process. The seals and sea lions that attack the cages with netting are comfortable swimming with the net on their face and head and will push very hard to bite at a fish. The present invention can include a essentially pointed cone or other shape during molding at the intersections perpendicular to the screen plane on the external surface that will discomfort the animal doing this activity. Therefore eliminating the need for the predator net and illegal shootings.

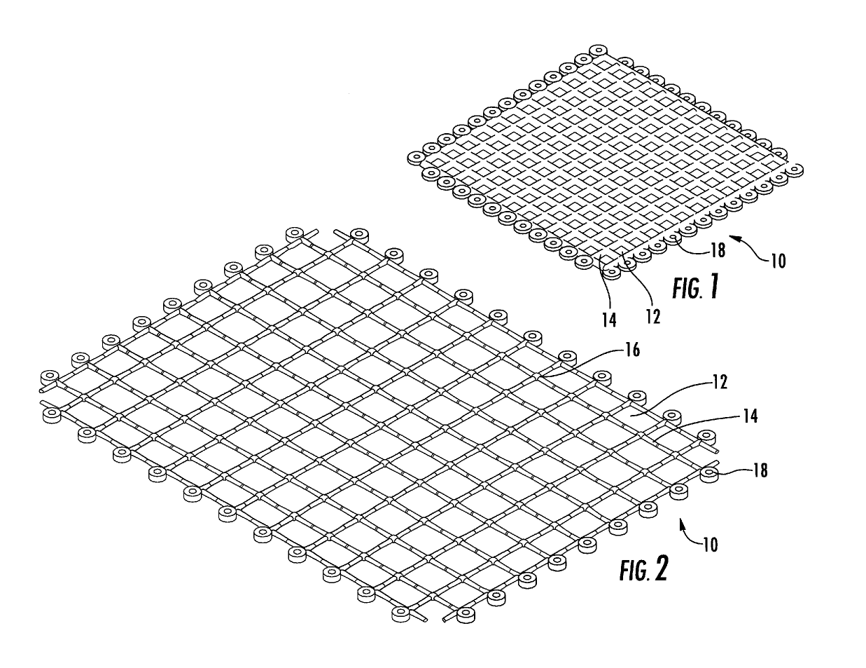

Referring to FIG. 1, set forth is a barrier screen 10 made by an injection molded part with multiple holes 12, essentially square, sized about ½ to ⅙ of the final desired opening size in a uniform pattern, including longitudinal elements 14 between such holes of 2 to 6 times the final desired screen barrier cross sectional area of the longitudinals respectively. Shown in FIG. 2, the longitudinal elements 14 of the molding are stretched to molecularly orient at elevated temperature to produce a larger planar dimension of 2 to 6 times plastic screen of high strength molecularly oriented monofilament longitudinal elements ½ to ⅙ the area respectively. Using a plastic polymer that will molecularly orient by mechanical means with strength of over 3,500 PSI as molded can be obtained by using PET or the like recyclable polymers. The material provides a low cost, green technology, that forms rounded dividers that are easy to clean, as well as providing superior strength when drawn. The plastic molding where the cross section 16 of the cylindrical elements are essentially round. The barrier screen includes an outer edge having features 18 that allow easy connection to the device used to stretch the cylindrical sections. The post stretching step includes devices to fix the stretched elements to a preset desired length preventing additional annealing or relaxation individually.

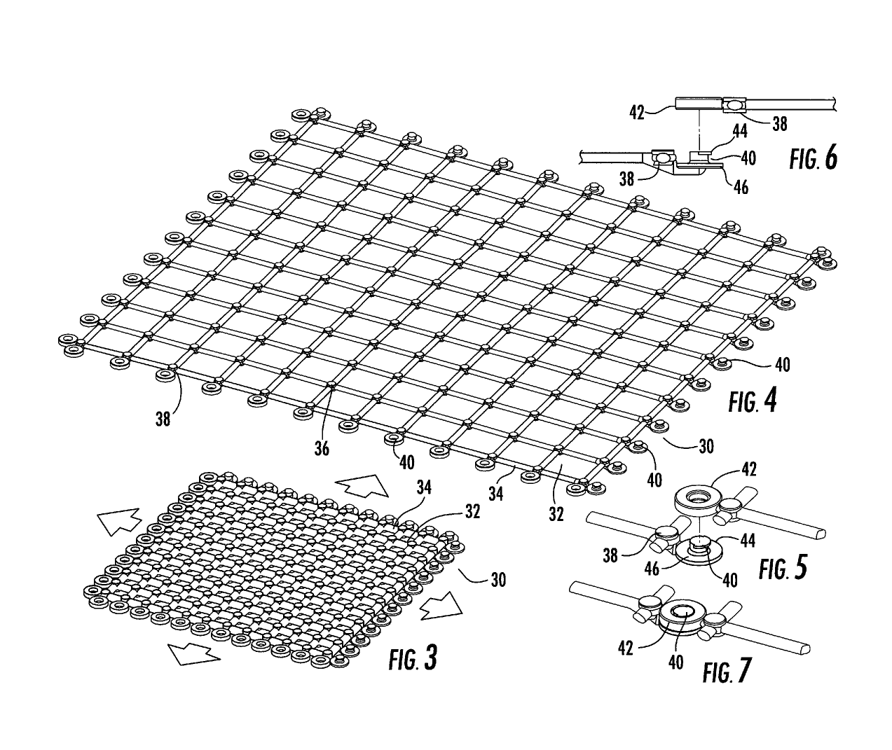

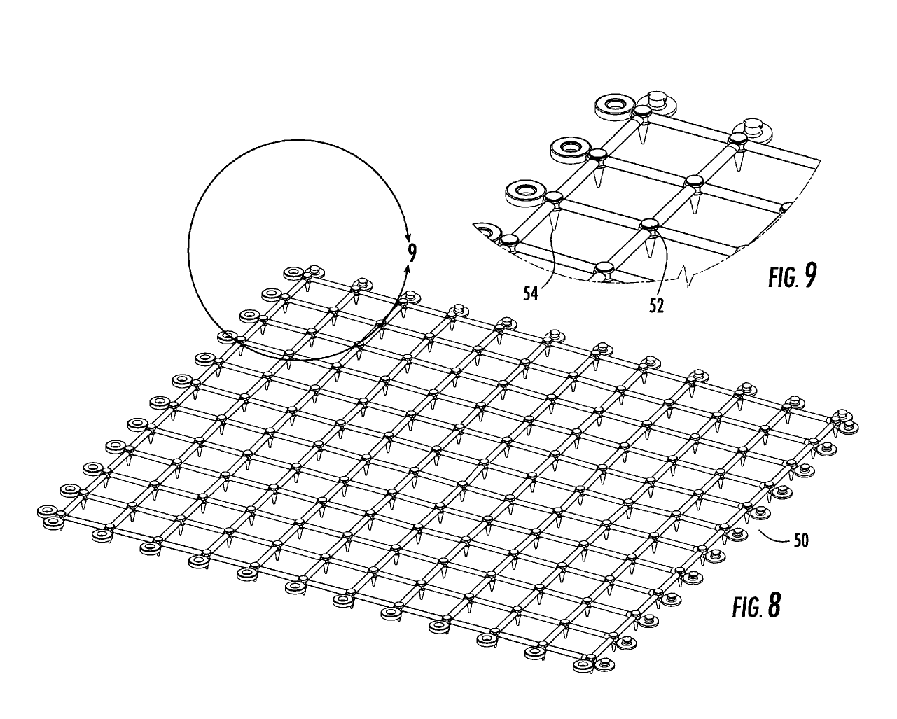

Referring to FIGS. 3-7, the molding procedure shown again discloses a barrier screen 30 made by an injection molded part with multiple holes 12, essentially square, sized about ½ to ⅙ of the final desired opening size in a uniform pattern, including longitudinal elements 34 between such holes of 2 to 6 times the final desired screen barrier cross sectional area of the longitudinals respectively. Shown in FIG. 4, the longitudinal elements 34 of the molding are stretched to molecularly orient at elevated temperature to produce a larger planar dimension of 2 to 6 times plastic screen of high strength molecularly oriented monofilament longitudinal elements ½ to ⅙ the area respectively. The plastic molding where the cross section 36 of the cylindrical elements are essentially round and retain the cross section shape of the molded part. The barrier screen 30 includes an outer edge having features 38 that allow easy connection to the device used to stretch the cylindrical sections. The post stretching step includes devices to fix the stretched elements to a preset desired length preventing additional annealing or relaxation individually. The perimeter features in this embodiment include a boss 40 that is insertable into a receptacle 42. In this embodiment, the boss 40 includes a locking tab 44 that engages the receptacle 42 locking similar parts together. A side wall 46 provides a support surface to the receptacle 42 forming a continuous surface. suitable to connect one finished stretched screen to another. Cooling the edge features prevent distortion while drawing and the intersections of the longitudinals have features effecting the final shape of the drawn intersection. The holes 32 can be square, hexagonal or other shapes.

In the drawing stance, as indicated by the arrows in FIG. 3, stretching and molecular orienting the longitudinal elements 34 in a first direction and stabilizing it from continuing to anneal or relax by a fixing means individually for each strand and then stretching in a second direction and holding to a desired final length. Alternatively the stretching can take place in both directions at one time. Alternatively the part can be removed from the molding machinery hot and stretched prior to complete cooling.

The temperature differential across the area to be stretched should not be more than about 10 degrees F. The intersection of perpendicular elements includes sufficient additional material to prevent sufficient molecular orientation at the intersection such that the second stretch is unaffected.

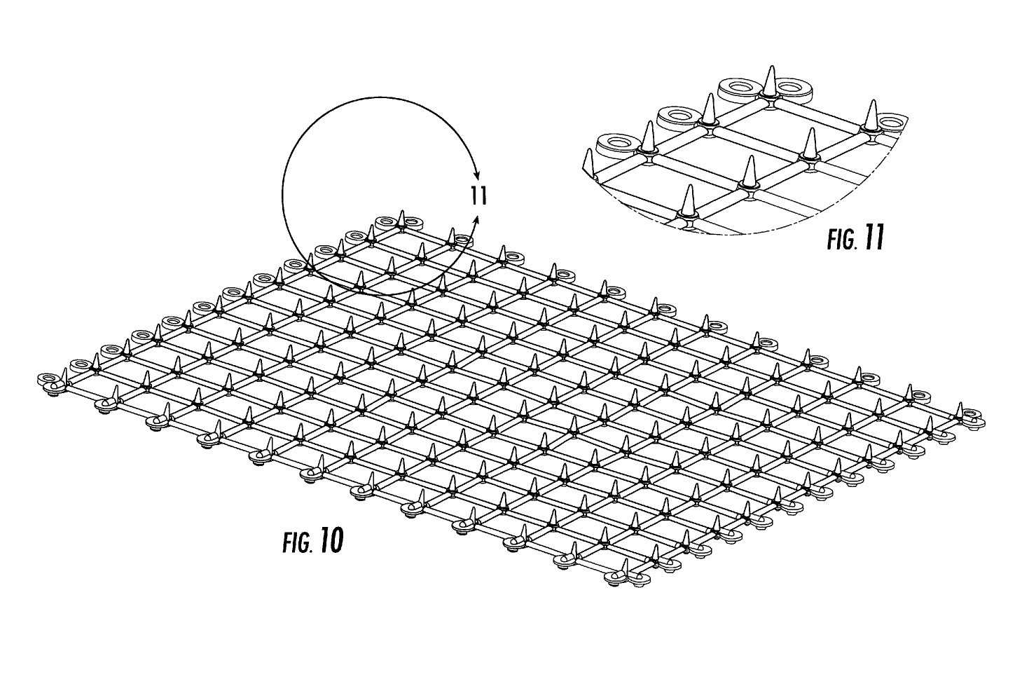

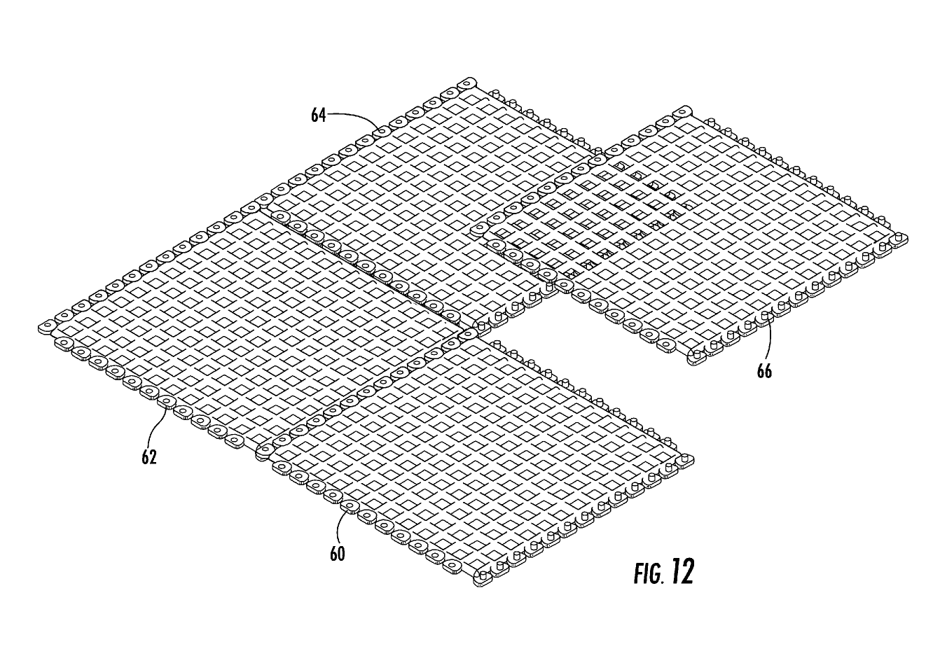

FIGS. 8-11 depict the barrier screen 50 where the intersections 52 of the molded face has protrusions 54 designed to deter predators from pushing on the screen. Such protrusions are also beneficial for use in a geogrid where the protrusions work as anchors to help prevent soil movement in relation to the barrier screen.

FIG. 12 depicts multiple screens 60, 62 and 64 coupled together with screen 66 readied for attachment to the stated screens. Aquaculture cages will experience two types of growth, which for reference will be called soft and hard. Soft growth is bacteria, fungus, algae, diatoms and grass. Hard growths are barnacles, oysters, mussels, clams, etc. Hard growths can be inhibited with a combination of surface finish and flexibility that affect their ability to attach. Controlling hard growth with screen extruded or molded plastics can be accomplished by keeping the flex modulas low enough to allow some flexing during use. The hard growths attachment gets stressed because the shell will not flex as screen flexing occurs and they cannot maintain attachment and fall off the screen. Flex modulas of plastics of 500 ksi and lower in diameters of 3.5 mm and smaller have been found effective to release hard growths of barnacles, clams, oysters and tube worms. Tensile strength of 8,000 psi have been found suitable with a surface durometer of D 75 or higher have been found effective against predators.

The screen or net is preferably of a bright color such as yellow, green, white or a translucent white. Because of the smooth surface growth is slower than conventional nylon fiber netting and cleaning is faster and easier. Further improvements with antimicrobials on the surface can be effective without pollution.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should by understood that the invention as claimed should not be unduly limited to such specific embodiments. Indeed, various modifications of the described modes for carrying out the invention which are obvious to those skilled in the art are intended to be within the scope of the following claims.

What is claimed is:

1. A plastic barrier screen formed from injection molding a part with multiple holes ½ to ⅙ of the final desired opening size in a uniform pattern, including longitudinal elements between such holes; heating and stretching the longitudinal elements of the molded part to molecularly orient monofilament longitudinal elements to produce a larger planar dimension barrier screen of about 2 to 6 times the original plastic screen.

2. The plastic barrier screen according to claim 1 wherein said injection molding a part is a plastic polymer that will molecularly orient by mechanical means with strength of over 3,500 PSI as molded.

3. The plastic barrier screen according to claim 1 wherein said molding includes essentially round cross sections of the cylindrical elements.

4. The plastic barrier screen according to claim 1 wherein the injection molded part has outer edge features that allow easy connection to the part used to post stretch the cylindrical sections.

5. The plastic barrier screen according to claim 4 wherein post stretching includes devices to fix the stretched parts to a preset desired length preventing additional annealing or relaxation individually.

6. The plastic barrier screen according to claim 4 wherein the perimeter features are constructed and arranged to connect one finished stretched screen to another.

7. The plastic barrier screen according to claim 4 wherein cooling the perimeter features prevent distortion while drawing.

8. The plastic barrier screen according to claim 4 including a means for cooling the perimeter features during the stretching process to prevent deformation of the perimeter features.

9. The plastic barrier screen according to claim 1 wherein intersections of the longitudinals have features effecting the final shape of the drawn intersection.

10. The plastic barrier screen according to claim 1 wherein the holes are square.

11. The plastic barrier screen according to claim 1 wherein the holes are hexagonal.

12. The plastic barrier screen according to claim 1 wherein the stretching and molecular orienting the screen cylindrical elements occur in a first direction and stabilizing the part from continuing to anneal or relax by a fixing means individually for each strand, and then stretching in a second direction and holding to a desired final length.

13. The plastic barrier screen according to claim 1 wherein the stretching and molecular orienting the screen cylindrical elements occurs in both directions at the same time.

14. The plastic barrier screen according to claim 1 wherein the part is removed from a molding machinery hot and stretched prior to complete cooling.

15. The plastic barrier screen according to claim 1 wherein the temperature differential across the area to be stretched is not more than 10 degrees F.

16. The plastic barrier screen according to claim 1 wherein the intersection of perpendicular elements includes sufficient additional material to prevent sufficient molecular orientation at the intersection such that the second stretch is unaffected.

17. The plastic barrier screen according to claim 1 wherein intersection of a molded face includes protrusions.

18. The plastic barrier screen according to claim 17 wherein said protrusions are cone shaped.
